(19) United States
(12) Patent Application Publication
(10) Pub. No.: US 2014/0256028 A1
(43) Pub. Date: Sep. 11, 2014

(54) SEMICONDUCTOR MICRO-ANALYSIS CHIP AND MANUFACTURING METHOD THEREOF

(71) Applicant: KABUSHIKI KAISHA TOSHIBA, Tokyo (JP)

(72) Inventors: Kentaro KOBAYASHI, Tokyo (JP); Hideto FURUYAMA, Yokohama-shi (JP)

(73) Assignee: KABUSHIKI KAISHA TOSHIBA, Tokyo (JP)

(21) Appl. No.: 14/012,566

(22) Filed: Aug. 28, 2013

(30) Foreign Application Priority Data
Mar. 7, 2013 (JP) 2013-045392

(51) Int. Cl. G01N 27/327

(52) U.S. Cl. CPC G01N 27/327
USPC 435/287.1; 216/2

(57) ABSTRACT

According to one embodiment, a semiconductor micro-analysis chip for detecting fine particles in sample liquid includes a semiconductor substrate, a first flow channel that is formed in the semiconductor substrate and into which the sample liquid is introduced, and a plurality of columnar structures fully arranged in the first flow channel at regulation distance.

### CROSS-REFERENCE TO RELATED APPLICATIONS

This application is based upon and claims the benefit of priority from Japanese Patent Application No. 2013-045392, filed Mar. 7, 2013, the entire contents of which are incorporated herein by reference.

### FIELD

Embodiments described herein relate generally to a semiconductor micro-analysis chip for detecting a fine particle sample and a manufacturing method thereof.

### BACKGROUND

In the field of biotechnology or health care, much attention is given to a micro-analysis chip having microfluidic devices such as a micro-flow channels and detection systems integrated therein. These micro-analysis chips are mainly made of glass substrates. In most cases, a flow channel formed in the glass substrate is capped by bonding a cover glass plate or the like thereon. As sample detection techniques, laser light scattering detection or fluorescent detection is often utilized.

However, if a glass substrate is used, it is difficult to form a minute structure. Further, it is necessary to form a lid of the flow channel by bonding the substrate thereon, which leads to difficulty in mass production of the devices. Therefore, there is a problem that the cost reduction is difficult.

### BRIEF DESCRIPTION OF THE DRAWINGS

FIG. 1 is a plan view showing the schematic configuration of a semiconductor micro-analysis chip according to a first embodiment.

FIG. 2 is a cross-sectional view showing the schematic configuration of the semiconductor micro-analysis chip according to the first embodiment.

FIGS. 3A to 3D are cross-sectional views showing manufacturing steps of the semiconductor micro-analysis chip of FIG. 1.

FIG. 4 is a cross-sectional view showing the configuration of a pillar.

FIG. 5 is a plan view showing the schematic configuration of a semiconductor micro-analysis chip according to a second embodiment.

FIG. 6 is a plan view showing the schematic configuration of a semiconductor micro-analysis chip according to a third embodiment.

FIGS. 7A to 7D are schematic views for illustrating a collection principle of particles trapped by use of the semiconductor micro-analysis chip of FIG. 6.

### DETAILED DESCRIPTION

In general, according to one embodiment, a semiconductor micro-analysis chip for detecting fine particles in sample liquid comprises a semiconductor substrate, a first flow channel that is formed in the semiconductor substrate and into which the sample liquid is introduced, and a plurality of columnar structures fully arranged in the first flow channel at regulation distance.

Embodiments are explained with reference to the drawings. In this case, though several concrete materials and configurations are taken as examples for the purpose of illustration, other materials and configurations having the same functions can also be used. Therefore, this invention is not limited to the following embodiments.

### First Embodiment

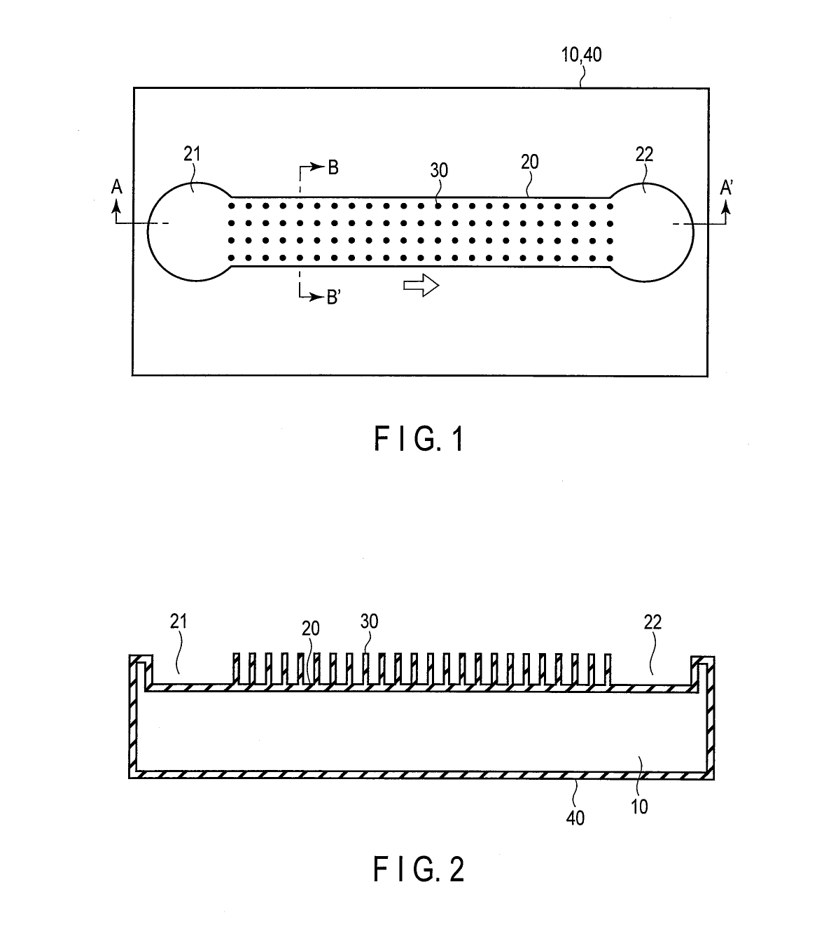

FIG. 1 is a plan view showing the schematic configuration of a semiconductor micro-analysis chip according to a first embodiment and FIG. 2 is a cross-sectional view taken along line A-A′ of FIG. 1.

In FIGS. 1 and 2, a reference symbol 10 denotes a semiconductor substrate and, for example, a Si substrate, Ge substrate or SiC substrate is used. In the following description, a case using a Si substrate is taken. A first flow channel 20 formed of a linear groove is formed in the surface portion of the semiconductor substrate 10.

The flow channel 20, which is formed by etching the surface portion of the Si substrate 10 with the width of 50 μm and the depth of 2 μm, for example, is used for flowing sample liquid containing to-be-detected fine particles. Fluid reservoir portions 21 and 22 which are used for injecting and discharging sample liquid, respectively, are provided on both ends of the flow channel 20. Electrodes can be inserted in the fluid reservoir portions 21 and 22. A pillar array (nano-pillars) 30 obtained by arranging columnar structures (pillars) that extend from the bottom surface of the flow channel 20 to the surface height of the Si substrate 10 at regulation distance is provided in a region other than both end portions of the flow channel 20. The diameter of the pillar is set to 1 μm, for example, and the distance between adjacent pillars is set to 0.5 μm, for example. Further, the distance between a side wall of the flow channel 20 and a side surface of the pillar that is closest to the side wall of the flow channel 20 is not more than the distance between adjacent pillars. The bottom portion of the flow channel 20 is covered with a SiO₂ film 40 and the nano-pillars 30 are formed of SiO₂.

With the above configuration, when sample liquid is injected into the fluid reservoir portion 21 of the flow channel 20, the sample liquid is drawn into the pillar gaps of the nano-pillars 30 by surface tension, flows in a horizontal direction, rightward in the drawing, and then reach the fluid reservoir portion 22. The surface portions of the flow channel 20 and the nano-pillars 30 are formed of hydrophilic SiO₂, and therefore, wettability of the flow channel can be attained by keeping suitable condition of its surfaces. The sample liquid flowing into the flow channel 20 is successively drawn into the gap of nano-pillars on the downstream side by surface tension and capillary action. As a result, the sample liquid in the flow channel 20 can flow without using an external pump or the like.

In the case that the sample liquid containing fine particles is flowing in the flow channel 20, the fine particles with smaller diameters than pillar interval P of the nano-pillars 30 can move towards the side of the fluid reservoir portion 22, and fine particles whose diameters are larger than P are trapped by the nano-pillars 30 at the boundary of the fluid reservoir portion 21 and the nano-pillars 30 and remain there. Therefore, only the fine particles with smaller diameters than pillar interval P of the nano-pillars 30 can be transferred to the fluid reservoir portion 22. Thus, the nano-pillars 30 fully arranged at regulation distance can be used as a size filter for fine particles. In addition, fine particles can be electrophoresed by inserting electrodes into the fluid reservoir portions 21 and 22 and applying a voltage between the fluid reservoir portions 21 and 22. At this time, the fine particles can be sorted by their sizes by the nano-pillars 30.

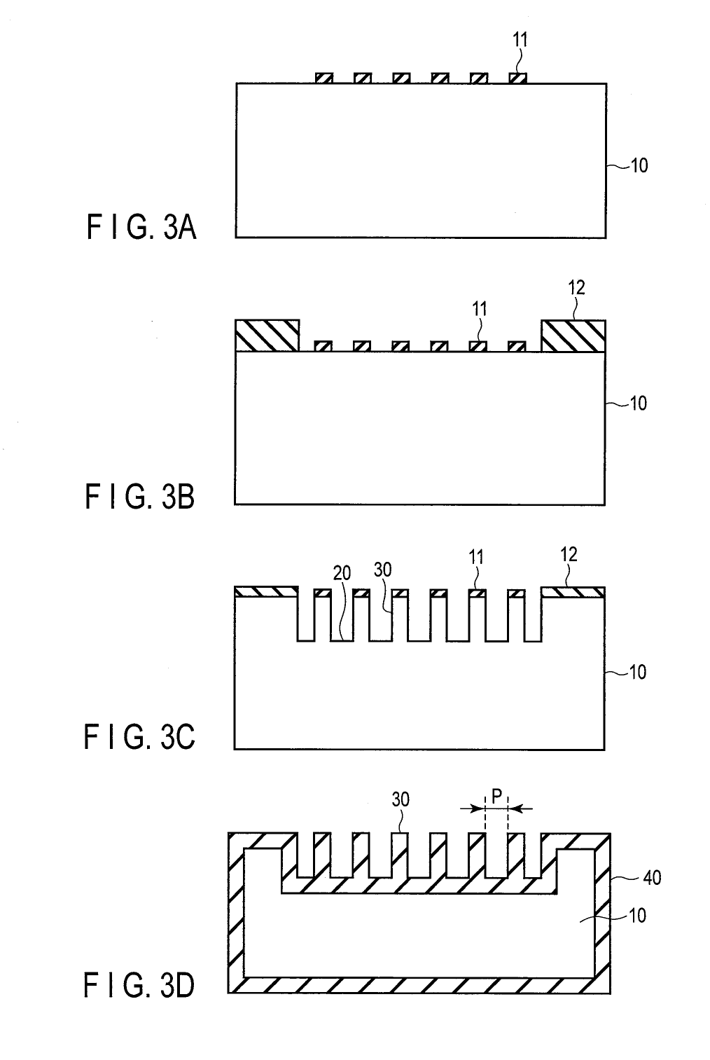

Next, a manufacturing method of the semiconductor micro-analysis chip according to the present embodiment is explained with reference to FIGS. 3A to 3D. FIGS. 3A to 3D correspond to the cross-sections taken along line B-B′ of FIG. 1.

First, as shown in FIG. 3A, a SiO₂ etching mask 11 used for forming nano-pillars is formed on a Si substrate 10. For example, the etching mask 11 is obtained by forming a SiO₂ film on the Si substrate 10, forming thereon a resist pattern of the nano-pillars and then etching the SiO₂ film with the resist mask.

Next, as shown in FIG. 3B, an etching mask 12 used for forming a flow channel is formed. The etching mask 12 is obtained by the process of forming a SiO₂ film, forming a resist pattern thereon and etching of the SiO₂ film, which is the same process for the etching mask 11. The etching mask 12 may be formed at the same time as formation of a mask used for formation of nano-pillars.

Then, as shown in FIG. 3C, a flow channel 20 and nano-pillars 30 are formed by reactive ion etching (RIE) of the Si substrate 10 using the masks 11 and 12.

Next, after removing the masks 11 and 12, a thermal oxidation process is performed to oxidize the entire portions of the nano-pillars 30 as shown in FIG. 3D. As a result, the nano-pillars 30 are turned form Si into SiO₂, and an exposed surface portion of the Si substrate 10 is covered with a silicon oxide film 40.

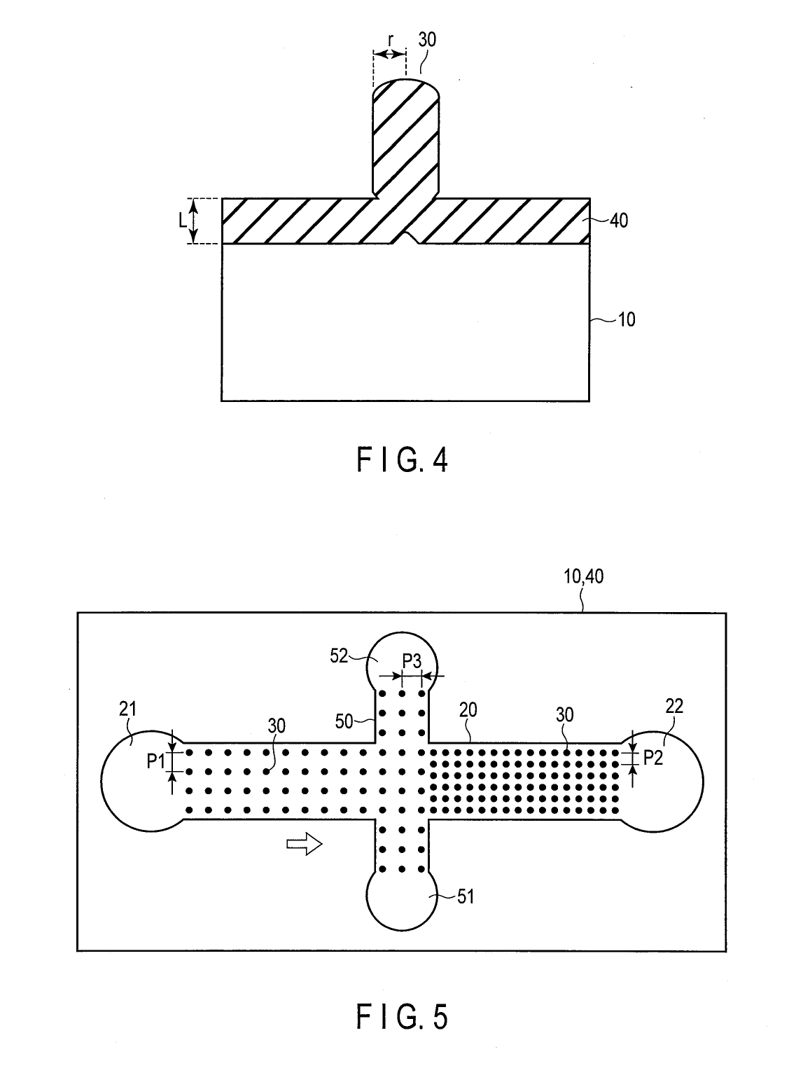

Looking at one of the nano-pillars 30, thickness L of the flat SiO₂ film 40 often becomes larger than radius r of the pillar as shown in FIG. 4. This is because the Si oxidation process does not further proceed in the nano-pillar portion after the whole portion of the pillar is oxidized, but the oxidation process proceeds according to the processing time in the flat portion of the Si substrate.

It is necessary to consider the following points when the Si nano-pillars in the flow channel 20 are oxidized. It is known that the molar volumes of Si and SiO₂ are 12.06 and 27.20 cm³, respectively, and the volume expands to 2.26 times when SiO₂ is formed by thermal oxidization of Si. In other words, when the nano-pillar surface is thermally oxidized, the value of the pillar diameter and the pillar interval varies from the ones obtained immediately after the Si substrate is etched. Therefore, if each oxidation rate of a plurality of Si pillars is varied at the time of the Si pillars not being completely oxidized, the diameters and intervals of the pillars will vary, which may result in loss of function of the nano-pillars as a particle size filter.

Meanwhile, when the thermal oxidation process is performed until the Si pillar is completely turned into SiO₂, the width (diameter) of the pillar does not increase any more, and therefore, SiO₂ pillars with almost the same diameters are obtained in case the diameters of the original Si pillars are almost the same. Since the volume ratio of Si and SiO₂ is already known as described above, the pillar diameters and intervals can be easily controlled by designing the pillar diameters and intervals in expectation of the amount of size change associated with complete oxidization of the Si pillar and by sufficiently oxidizing the Si substrate enough to oxidize the nano-pillars completely.

As described above, since surface tension in the flowing direction of the flow channel 20 is raised by the nano-pillars 30 arranged all over the flow channel 20, a lid on the top of the flow channel 20 is not indispensable. As a result, the substrate bonding process for forming the lid of the flow channel 20 can be omitted and the manufacturing cost can be suppressed. Of course, if the cost permits, a cap may be formed on the top of the flow channel 20. In this case, surer capillary action can be caused, and moreover, impurity incorporation into the flow channel 20 can be prevented. In order to form the cap of the flow channel 20, for example, a resin-made sacrifice layer such as polyimide is selectively formed in the flow channel 20 and then the film of SiO₂, Si₃N₄ or the like is formed thereon. Next, fluid reservoir portions 21 and 22 are formed and the sacrifice layer may be removed by oxygen plasma ashing or the like through the fluid reservoir portions 21 and 22.

Thus, according to this embodiment, the micro-analysis chip can be realized utilizing a normal semiconductor manufacturing process with the Si substrate 10. Therefore, it becomes possible to realize a small and mass-productive semiconductor micro-analysis chip that can detect viruses, bacteria or the like with high sensitivity, at low cost.

In addition, since the nano-pillars 30 are fully arranged at regulation distance in the flow channel 20, sample liquid can effectively flow in the flow channel 20. Furthermore, since the movement of fine particles is controlled according to pillar interval P of the nano-pillars 30, among the fine particles contained in the sample liquid injected from the fluid reservoir portion 21, only the fine particles with the diameter smaller than the pillar interval P can move through the nano-pillars 30.

### Second Embodiment

FIG. 5 is a plan view showing the schematic configuration of a semiconductor micro-analysis chip according to a second embodiment. Portions that are the same as those of FIG. 1 are denoted by the same symbols and the detailed explanation thereof is omitted.

In FIG. 5, like the first embodiment, a first flow channel 20 formed of a linear groove is formed in the surface portion of a Si substrate (semiconductor substrate) 10. Further, a second flow channel 50 is formed in a direction perpendicular to the first flow channel 20 to be positioned roughly in the central portion of the first flow channel 20. Pillar pitches of nano-pillars 30 located on the upstream side (on the fluid reservoir 21 side) and on the downstream side (on the fluid reservoir 22 side) of the first flow channel 20 are different from each other, and the pillar pitches on the downstream side are set smaller than the ones on the upstream side. That is, the pillar interval P2 on the downstream side is set narrower than the pillar interval P1 on the upstream side. Nano-pillars 30 are also arranged in the second flow channel 50 and the pillar interval P3 thereof is set to the same as the pillar interval P1 on the upstream side of the first flow channel 20.

With the above configuration, when sample liquid is injected into the fluid reservoir portion 21 of the first flow channel 20, the sample liquid is guided by the nano-pillars 30 and flows from the fluid reservoir portion 21 to the direction of the fluid reservoir portion 22 side. That is like the first embodiment, the sample liquid flows in the first flow channel 20 without using electrophoresis.

Unlike the first embodiment, in the present embodiment, the pillar interval of the nano-pillars 30 is set smaller on the downstream side of the first flow channel 20 than on the upstream side. Therefore, fine particles of the diameter smaller than the pillar interval P2 reach the fluid reservoir portion 22. However, fine particles of the diameter smaller than the pillar interval P1 and larger than the pillar interval P2 remain in a boundary region between the upstream side and the downstream side. Of course, particles of the diameter larger than the pillar interval P1 cannot flow into the flow channel 20.

With the above configuration, fine particles that remain at the boundary of the nano-pillars with interval P1 and the ones with interval P2 can be transferred to one of the fluid reservoir portions of the second flow channel 50, for example, to the fluid reservoir portion 52 by inserting electrodes into the fluid reservoir portions 51 and 52 of the second flow channel 50 and applying a voltage between them. Thus, fine particles that are smaller than pillar interval P1 and larger than P2 can be densely collected in the fluid reservoir portion 52.

According to this embodiment, the micro-analysis chip can be realized by use of a normal semiconductor device manufacturing process using the Si substrate 10. Further, since the nano-pillars 30 arranged at regulation distance in the first flow channel 20, sample liquid effectively flows in the first flow channel 20 merely by surface tension. Therefore, the same effect as that of the first embodiment can be attained. Furthermore, only the fine particles of the specified size (the diameter is smaller than P1 and larger than P2) can be densely collected in one of the fluid reservoir portions of the second flow channel 50 by setting the pillar pitches of the nano-pillars 30 to different values, P1 on the upstream side and P2 on the downstream side of the first flow channel 20 and providing the second flow channel 50 perpendicular to the first flow channel 20. This becomes significantly effective in detecting fine particles of the specified size.

Furthermore, according to this embodiment, two different-sized fine particles can be separately collected when sample liquid include two different-sized fine particles, that is, fine particles with diameter smaller than pillar interval P1 and larger than pillar interval P2 and ones with diameter smaller than pillar interval P2. Therefore, the two types of fine particles can be collected or detected in independent regions.

### Third Embodiment

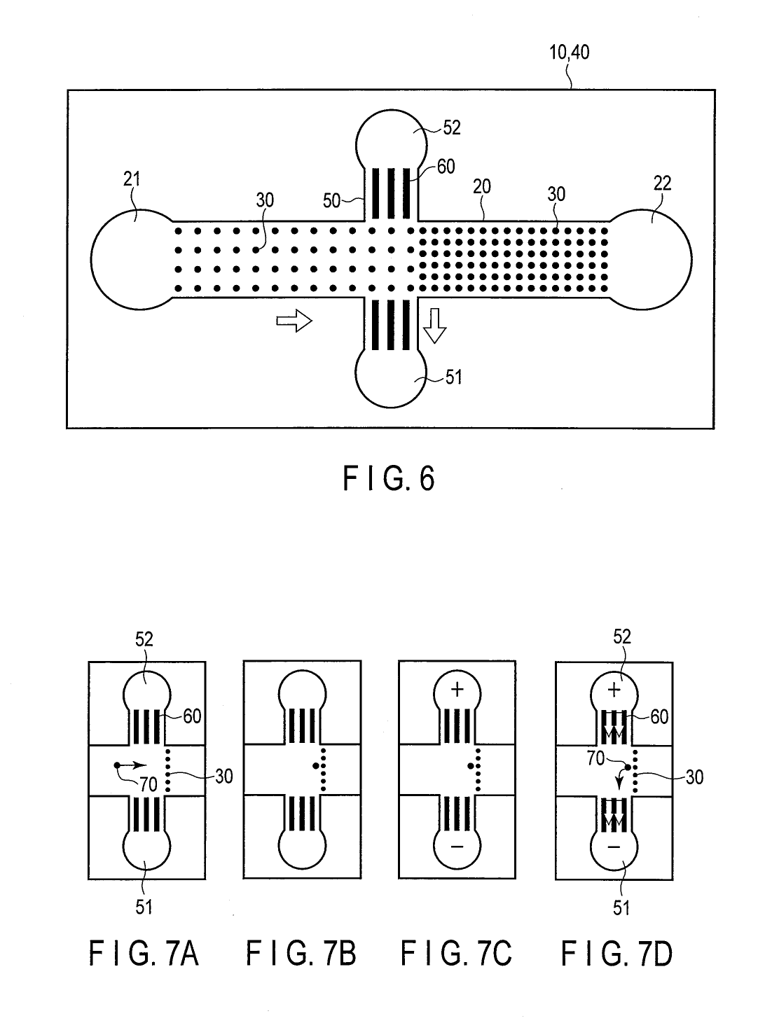

FIG. 6 is a plan view showing the schematic configuration of a semiconductor micro-analysis chip according to a third embodiment. Portions that are the same as those of FIG. 2 are denoted by the same symbols and the detailed explanation thereof is omitted.

The present embodiment is different from the second embodiment explained before in that slit-form nano-walls (wall-shaped structures) 60 are provided instead of the nano-pillars 30 provided in the second flow channel 50. That is, a plurality of nano-walls 60 with interval P3, which is the same as pillar interval P1, are arranged along the flow channel direction in the second flow channel 50. The nano-walls 60 can be formed in the same manner as formation of the nano-pillars 30 by an etching process using a SiO₂ mask. With this configuration, the same effect as that of the second embodiment can be attained.

In addition, fine particles that are trapped in the boundary between the upstream side and the downstream side of the first flow channel 20 can be collected with high efficiency by inserting electrodes into the fluid reservoir portions 51 and 52 of the second flow channel 50 and applying a voltage between them. The principle is explained with reference to FIGS. 7A to 7D.

FIGS. 7A to 7D are drawings showing a portion near where the first flow channel 20 and the second flow channel 50 are intersecting. Nano-pillars of the first flow channel 20 are shown only in the boundary portion between the upstream side and the downstream side for simplicity.

First, as shown in FIG. 7A, sample liquid introduced into an fluid reservoir portion 21 of the first flow channel 20 flows via the nano-pillars and moves to the fluid reservoir portion 22 side. Along with this, fine particles smaller than the pillar interval P1 of the nano-pillars 30 of the flow channel 20 are transferred to the fluid reservoir portion 22 side. Then, fine particles 70 with the diameter larger than the pillar interval P2 will remain in front of the downstream region of the flow channel 20 as shown in FIG. 7B.

Then, as shown in FIG. 7C, a negative electrode is inserted into the fluid reservoir portion 51 of the second flow channel 50 and a positive electrode is inserted into the fluid reservoir portion 52 and a voltage is applied therebetween. Generally, the surface of SiO₂ is negatively charged and positive charges in the sample liquid, which is forming an electrical double layer attracted by the negative charges on the surface of the second flow channel 20 and the surface of the nano-walls 60, are attracted towards the negative electrode inserted into the fluid reservoir portion 52. Owing to this, a so-called electro-osmotic flow in which sample liquid near the SiO₂ surface moves to the negative electrode side occurs. As shown in FIG. 7D, the fine particles 70 remaining in the boundary between the upstream side and the downstream side of the first flow channel 20 can be transferred to the fluid reservoir portion 51 according to the electro-osmotic flow. That is, the fine particles 70 remaining in the boundary are smoothly transferred to the fluid reservoir portion 51 of the second flow channel 50 by pumping effect of an electro-osmotic pump by means of the nano-walls 60.

Thus, according to this embodiment, the same effect as that of the second embodiment can be obtained and an advantage that fine particles can be separately collected with higher efficiency by forming the nano-walls 60 is obtained.

(Modification)

This invention is not limited to the above embodiments.

In the embodiments, the Si substrate is used as the semiconductor substrate, but the substrate is not limited to Si and another semiconductor can be used if a groove and pillars can be formed by use of a normal semiconductor manufacturing process.

In the first embodiment, the whole portion of the columnar structure is oxidized, but only the surface thereof may be oxidized. Further, the structure can be used as it is without being oxidized. Likewise, the whole portion of the wall-shaped structures can be oxidized and only the surface thereof may be oxidized.

Further, in the second and third embodiments, the second flow channel is provided to intersect with the first flow channel at right angles, but it is not always necessary to intersect the flow channels at right angles and it is sufficient if the second flow channel intersects with the first flow channel at any angle.

In the second and third embodiments, one second flow channel intersects with the first flow channel, but a plurality of second flow channels may be provided. In this case, the pillar pitches of the nano-pillars provided in the first flow channel are divided into three or more stages and the second flow channels are respectively provided on the boundary portions thereof, and as a result, particles with two or more types of sizes can be separately collected.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor micro-analysis chip for detecting fine particles in sample liquid, comprising:
a semiconductor substrate,
a first flow channel provided in the semiconductor substrate, the sample liquid being introduced into the first flow channel, and
a plurality of columnar structures fully laid at preset arrangement intervals in the first flow channel.

2. The chip according to claim 1, wherein the first flow channel includes a groove formed in a surface portion of the semiconductor substrate.

3. The chip according to claim 1, further comprising an fluid reservoir portion configured to inlet of the sample liquid and formed on one end side of the first flow channel and an fluid reservoir portion configured to outlet of the sample liquid and formed on the other end side of the first flow channel.

4. The chip according to claim 3, wherein the fluid reservoir portions permit insertion of electrodes therein.

5. The chip according to claim 1, wherein the semiconductor substrate is formed of Si and the columnar structures are formed of one of Si, SiO₂ and a composite material thereof.

6. The chip according to claim 5, wherein the first flow channel and the second flow channel comprise surfaces formed of either Si or SiO₂.

7. The chip according to claim 6, wherein the first flow channel and the second flow channel comprise flat portions formed of SiO₂ and having a thickness greater than a radius of the columnar structures.

8. The chip according to claim 5, wherein the columnar structures are formed of SiO₂ and comprise an Si—SiO₂ interface at lower portions thereof, the Si—SiO₂ interface being convex toward the columnar structures.

9. The chip according to claim 1, wherein an interval between a side wall of the flow channels and a side wall of the columnar structures that is closest to the side wall of the flow channels is not more than an interval between the columnar structures.

10. The chip according to claim 1, wherein the first flow channel is divided into upstream and downstream regions and the arrangement interval of the columnar structures is narrower in the downstream region than in the upstream region.

11. The chip according to claim 10, further comprising a second flow channel that is provided to intersect with the first flow channel, the columnar structures being fully laid in the second flow channel at the same pitch as the columnar structures interval on the upstream side of the first flow channel.

12. The chip according to claim 10, further comprising a second flow channel that is provided to intersect with the first flow channel, wall-shaped structures being arranged in the second flow channel at the same pitch as the columnar structures interval on the upstream side of the first flow channel along the second flow channel.

13. The chip according to claim 11, wherein the semiconductor substrate is formed of Si and the columnar structures are formed of one of Si, SiO₂ and a composite material thereof.

14. The chip according to claim 12, wherein the semiconductor substrate is formed of Si and the columnar structures are formed of one of Si, SiO₂ and a composite material thereof.

15. A semiconductor micro-analysis chip for detecting fine particles in sample liquid, comprising:
a semiconductor substrate formed of Si,
a first flow channel provided in the semiconductor substrate, the sample liquid being introduced into the first flow channel,
first columnar structures formed of one of Si, SiO₂ and a composite material thereof, the first columnar structures being fully laid in the first flow channel at preset arrangement intervals and the arrangement interval being narrower in a downstream region of the first flow channel than in an upstream region thereof,
a second flow channel provided to intersect with the first flow channel, and
second columnar structures formed of one of Si, SiO₂ and a composite material thereof, the second columnar structures being fully laid in the second flow channel at the same pitch as the columnar structures interval on the upstream side.

16. The chip according to claim 15, wherein each of the first and second flow channels includes a groove formed in a surface portion of the semiconductor substrate.

17. The chip according to claim 15, further comprising fluid reservoir portions that are formed at both ends of the second flow channel, the fluid reservoir portions permitting insertion of electrodes therein.

18. A manufacturing method of a semiconductor micro-analysis chip for detecting fine particles in sample liquid, comprising:
forming a flow channel etching mask formed in a pattern of a flow channel and a column etching mask corresponding to columnar structures on a semiconductor substrate, and
etching the semiconductor substrate from the surface thereof to preset depth by use of the respective etching masks to form a flow channel that permits the sample liquid to flow and a plurality of columnar structures fully laid in the flow channel.

19. The method according to claim 18, wherein a Si substrate is used as the semiconductor substrate.

20. The method according to claim 19, wherein the columnar structures formed by etching are oxidized.
